(19) United States
(12) Patent Application Publication
(10) Pub. No.: US 2026/0244134 A1
(43) Pub. Date: Aug. 20, 2026

(54) ESTIMATING SYSTEM, ELECTRONIC APPARATUS, AND ESTIMATING METHOD

(71) Applicant: KYOCERA DOCUMENT SOLUTIONS INC., OSAKA (JP)

(72) Inventors: RYOTA YAGANE, OSAKA (JP); NAOKI TAKEUCHI, OSAKA (JP); MASAHIRO SUZUKI, OSAKA (JP); MANORI DISSANAYAKE, OSAKA (JP)

(21) Appl. No.: 19/536,145

(22) Filed: Feb. 10, 2026

(30) Foreign Application Priority Data
Feb. 17, 2025 (JP) 2025-023713

(51) Int. Cl. G03G 15/00; G06F 1/28; G06F 1/3203; G06F 1/3206; G06F 1/3287; G06F 11/30

(52) U.S. Cl. CPC G03G 15/5016; G03G 15/5004; G06F 1/28; G06F 1/3203; G06F 1/3206; G06F 1/3287; G06F 11/3062

(57) ABSTRACT

An estimating system includes an estimator that obtains an estimated value of power consumption caused when an electronic apparatus executes a job, using a power consumption estimating model that is a regression model used to estimate the power consumption. The regression model is created by a decision tree algorithm. A target variable of the regression model represents the power consumption. An explanatory variable of the regression model represents execution information regarding execution of a job, set-value information regarding a set value for a state of the electronic apparatus, and time information regarding a time taken for the job or duration of the state. There exists a plurality of the explanatory variables of the regression model depending on a type of a setting for the job or the state of the electronic apparatus.

### CROSS-REFERENCE TO RELATED PATENT APPLICATION

This application claims the benefit of Japanese Priority Patent Application JP 2025-023713 filed February 17, 2025, the entire contents of which are incorporated herein by reference.

### FIELD OF THE DISCLOSURE

The present disclosure relates to an electronic apparatus, an estimating system that estimates power consumption of the electronic apparatus, and an estimating method for estimating the power consumption.

### BACKGROUND OF THE DISCLOSURE

In related art, an estimating system that obtains an estimated value of carbon dioxide emissions of an image forming apparatus is known. The estimated value of the carbon dioxide emissions is obtained as indicated below. A reference power quantity obtained by measuring power consumption in advance is multiplied by a print mode coefficient that corresponds to a print mode representing whether to perform color printing or black-and-white printing, and a value obtained by the multiplication is further multiplied by a layout coefficient that corresponds to a layout representing the number of pages printed on a sheet of paper. Accordingly, power consumption caused when an image forming apparatus executes a single job is obtained. The obtained power consumption is multiplied by carbon dioxide emissions per unit power consumption to obtain the estimated value of the carbon dioxide emissions. Typically, the reference power quantity is, for example, power quantity consumed upon performing, for example, black-and-white printing on a single A4-sized page. The print mode coefficient is set to "1" in a print mode in which black-and-white printing is performed, and is set to a value larger than "1" in a print mode in which color printing is performed. The layout coefficient is set to "1" in the case of "none", which represents a layout with which a single page of a document is printed on one of sides of a sheet of paper, and is set to "0.5" in the case of "2in1", which represents a layout with which two pages of the document are printed one of the sides of the sheet of paper. Further, the layout coefficient is set to "0.25" in the case of "4in1", which represents a layout with which four pages of the document are printed one of the sides of the sheet of paper, and is set to "0.125" in the case of "8in1", which represents a layout with which eight pages of the document are printed one of the sides of the sheet of paper.

Further, another estimating system that obtains an estimated value of carbon dioxide emissions of an image forming apparatus is known. The estimated value of the carbon dioxide emissions is obtained as indicated below. Power consumption defined for each operation section and determined by a setting for printing is multiplied by the number of times of operation performed by the operation section, where the number of times of operation is determined by the number of sheets of paper printed and the number of sides on which printing is performed. Accordingly, power consumption caused when the image forming apparatus executes a single job is obtained. The obtained power consumption is multiplied by a coefficient of carbon dioxide emissions due to electric power to obtain the estimated value of the carbon dioxide emissions.

### SUMMARY OF THE DISCLOSURE

An estimating system according to an embodiment of the present disclosure includes an estimator that obtains an estimated value of power consumption caused when an electronic apparatus executes a job, using a power consumption estimating model that is a regression model used to estimate the power consumption. The regression model is created by a decision tree algorithm. A target variable of the regression model represents the power consumption. An explanatory variable of the regression model represents execution information regarding execution of a job, set-value information regarding a set value for a state of the electronic apparatus, and time information regarding a time taken for the job or duration of the state. There exists a plurality of the explanatory variables of the regression model depending on a type of a setting for the job or the state of the electronic apparatus.

An electronic apparatus according to an embodiment of the present disclosure includes an estimator that obtains an estimated value of power consumption caused when the electronic apparatus executes a job, using a power consumption estimating model that is a regression model used to estimate the power consumption. The regression model is created by a decision tree algorithm. A target variable of the regression model represents the power consumption. An explanatory variable of the regression model represents execution information regarding execution of a job, set-value information regarding a set value for a state of the electronic apparatus, and time information regarding a time taken for the job or duration of the state. There exists a plurality of the explanatory variables of the regression model depending on a type of a setting for the job or the state of the electronic apparatus.

An estimating method according to an embodiment of the present disclosure is performed by an estimating program being executed by a control circuit of an electronic apparatus, the estimating method including obtaining an estimated value of power consumption caused when the electronic apparatus executes a job, using a power consumption estimating model that is a regression model used to estimate the power consumption. The regression model is created by a decision tree algorithm. A target variable of the regression model represents the power consumption. An explanatory variable of the regression model represents execution information regarding execution of a job, set-value information regarding a set value for a state of the electronic apparatus, and time information regarding a time taken for the job or duration of the state. There exists a plurality of the explanatory variables of the regression model depending on a type of a setting for the job or the state of the electronic apparatus.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 is a block diagram of an example of an image forming apparatus that serves as an estimating system according to an embodiment of the present disclosure.

FIG. 2 illustrates an example of job history information illustrated in FIG. 1.

FIG. 3 is a block diagram of an example of an estimating model generating system used to generate an estimating model used by the image forming apparatus illustrated in FIG. 1.

FIG. 4 is a flowchart of a method for generating the estimating model used by the image forming apparatus illustrated in FIG. 1.

FIG. 5 is a flowchart of an operation performed by the image forming apparatus of FIG. 1 upon executing a copying job.

FIG. 6 is a flowchart of an operation performed by the image forming apparatus of FIG. 1 upon displaying a total of carbon dioxide emissions.

FIG. 7 is a block diagram of an example of an estimating system according to an embodiment of the present disclosure that is different from the example illustrated in FIG. 1.

FIG. 8 illustrates an example of a power consumption estimating model that is a regression model created by a decision tree algorithm.

### DETAILED DESCRIPTION OF THE EXEMPLARY EMBODIMENTS

The existing estimating systems only provide less accurate estimated values of power consumption of the image forming apparatuses.

In view of the circumstances described above, the present disclosure improves the accuracy of an estimated value of power consumption of the electronic apparatus.

Hereinafter, embodiments of the present disclosure will be described with reference to the drawings. In the present embodiment, an image forming apparatus such as a multifunction peripheral is described as an electronic apparatus. However, another type of electronic apparatus may be acceptable.

First, a configuration of an image forming apparatus that serves as an estimating system according to an embodiment of the present disclosure is described.

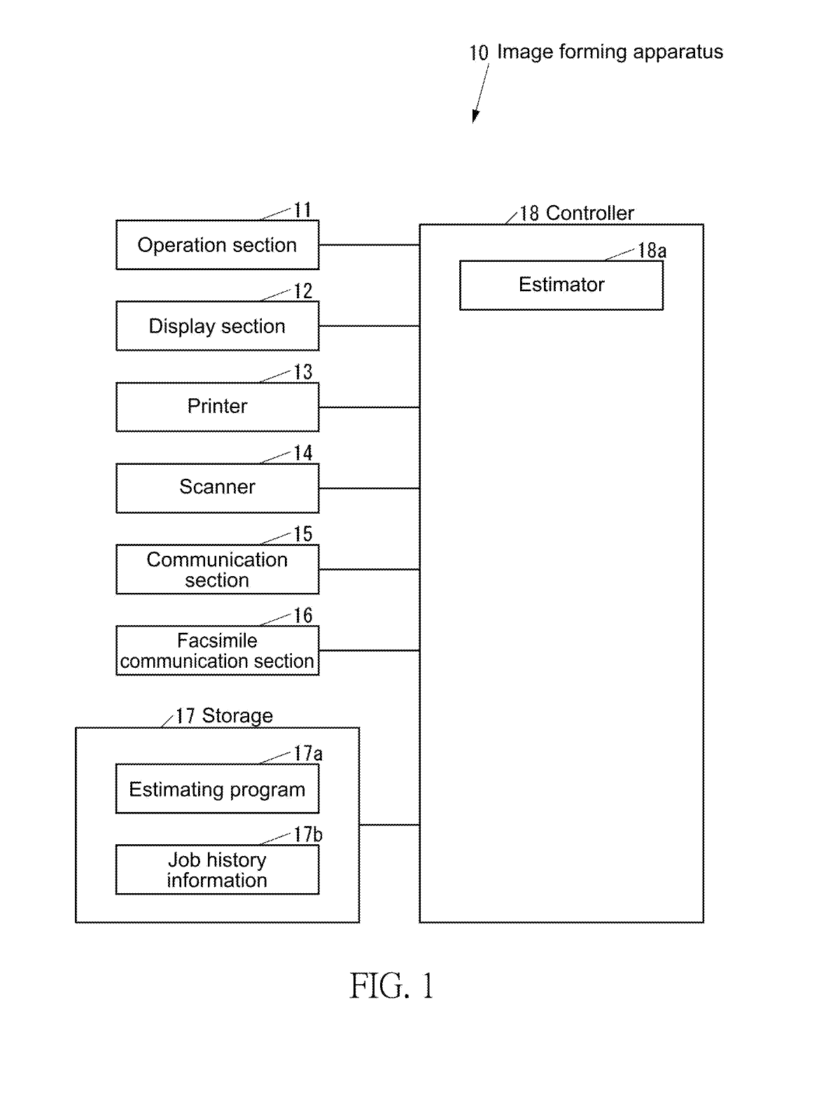

FIG. 1 is a block diagram of an example of an image forming apparatus 10 according to the present embodiment.

As illustrated in FIG. 1, the image forming apparatus 10 is a computer that includes an operation section 11, a display section 12, a printer 13, a scanner 14, a communication section 15, a facsimile communication section 16, a storage 17, and a controller 18. The operation section 11 is an operation device, such as a button, that is used to input various operations. The display section 12 is a display device, such as a liquid crystal display (LCD), that displays thereon various information. The printer 13 is a printing device that prints an image on a recording medium such as a sheet of paper. The scanner 14 is a reading device that reads an image of a document. The communication section 15 is a communication device that communicates with an external apparatus via a network such as a local area network (LAN) or the Internet, or that directly communicates with the external apparatus wirelessly or by wire without any networks. The facsimile communication section 16 is a facsimile device that performs facsimile communication with an external facsimile apparatus (not illustrated) via a communication line such as a public telephone line. The storage 17 is a nonvolatile storage device, such as a semiconductor memory or a hard disk drive (HDD), that stores therein various information. The controller 18 controls the entirety of the image forming apparatus 10.

The storage 17 can store therein an estimating program 17a used to estimate carbon dioxide emissions of the image forming apparatus 10. For example, the estimating program 17a may be installed on the image forming apparatus 10 in process of manufacturing the image forming apparatus 10, may be additionally installed on the image forming apparatus 10 from an external medium such as a Universal-Serial-Bus (USB) memory, or may be additionally installed on the image forming apparatus 10 from the network.

The storage 17 can store therein job history information 17b that stores therein a history of a job executed by the image forming apparatus 10.

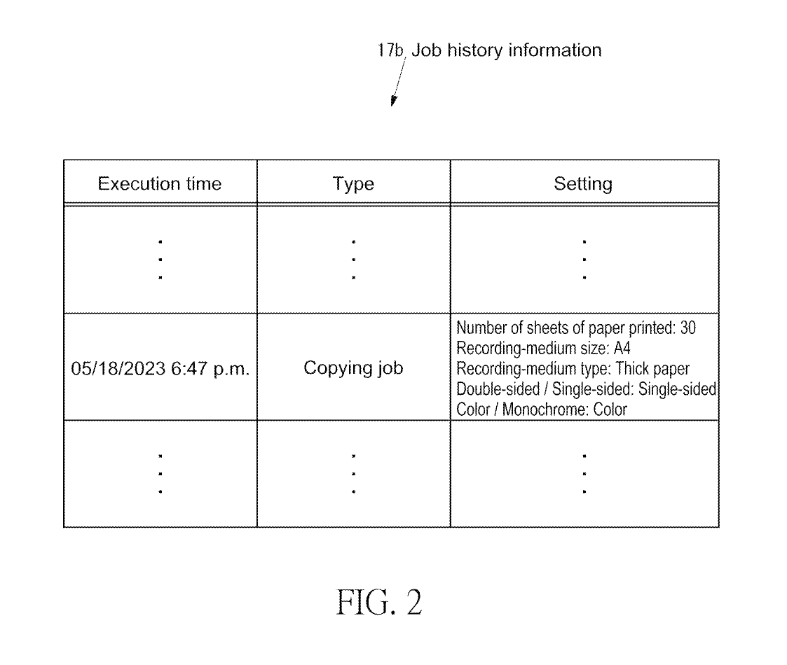

FIG. 2 illustrates an example of the job history information 17b.

As illustrated in FIG. 2, a history stored in the job history information 17b includes, for each job, a time taken to execute the job, the type of the job such as a copying job or a printing job, and a setting for the job. The history stored in the job history information 17b includes all of the information necessary to estimate carbon dioxide emissions using an estimating model described later.

The controller 18 illustrated in FIG. 1 includes, for example, a central processing unit (CPU), a read only memory (ROM) that stores therein a program and various data, and a random access memory (RAM) that is a memory used as a working region for the CPU of the controller 18. The CPU of the controller 18 executes the program stored in the storage 17 or in the ROM of the controller 18.

The controller 18 executes the estimating program 17a to provide an estimator 18a that estimates carbon dioxide emissions of the image forming apparatus 10, and to perform an estimating method for estimating the carbon dioxide emissions.

A specific example of a power consumption estimating model that is a regression model used by the estimator 18a to estimate carbon dioxide emissions caused when the image forming apparatus 10 executes a single job, is described below.

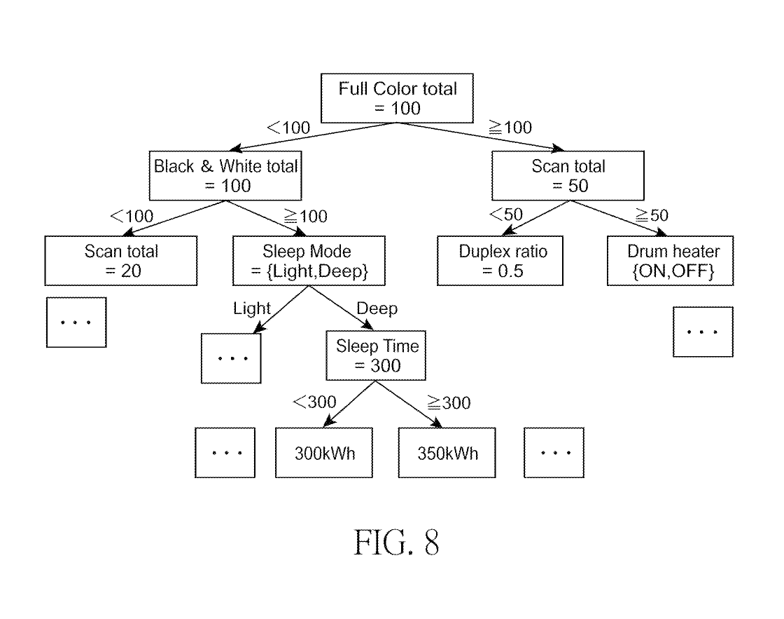

FIG. 8 illustrates an example of a power consumption estimating model that is a regression model created by a decision tree algorithm.

The estimator 18a obtains an estimated value of power consumption caused when the image forming apparatus 10 executes a job, using a power consumption estimating model that is a regression model used to estimate power consumption. The estimator 18a obtains an estimated value of carbon dioxide emissions by multiplying the estimated value of power consumption by a coefficient of carbon dioxide emissions. The regression model is created by a decision tree algorithm. A target variable of the regression model represents power consumption. An explanatory variable of the regression model represents execution information regarding execution of a job, set-value information regarding a set value for a state of the image forming apparatus 10, and time information regarding a time taken for the job or duration of the state. There exists a plurality of the explanatory variables of the regression model depending on the type of a setting for the job or the state of the image forming apparatus 10.

In the present embodiment, the power consumption estimating model corresponding to a regression model is created by, for example, a decision tree algorithm, using power consumption as a target variable and using, as explanatory variables, job execution information including the number of sheets of paper printed and the number of sheets of paper copied, set-value information including light sleep, deep sleep, and a drum-heater setting, and information indicating respective times. FIG. 8 illustrates a tree showing an interior of an example of the power consumption estimating model. For example, when Full Color total is less than 100, Black & White total is greater than or equal to 100, Sleep Mode is Deep, and Sleep time is greater than or equal to 300, a value of power consumption is estimated to be 350 kWh.

An algorithm using a single tree, or an algorithm (ensemble learning) that calculates a value obtained by averaging results of a plurality of trees generated in advance, or combining some of the results on the basis of a majority decision, may be adopted for the power consumption estimating model. Compared to the use of a single model, the ensemble learning provides a higher degree of accuracy. In other words, the estimator 18amay calculate the estimated value of power consumption by the ensemble learning in which results obtained using the power consumption estimating model including a plurality of regression models are averaged or some of the results are combined on the basis of a majority decision.

Next, a configuration of an estimating model generating system used to generate the estimating model is described.

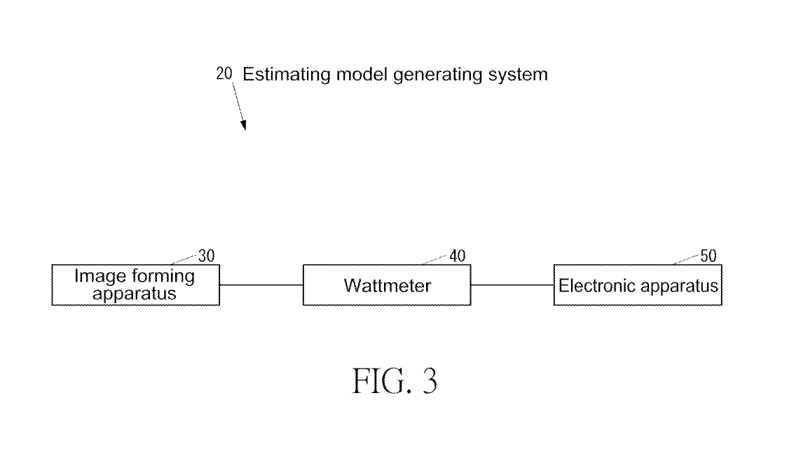

FIG. 3 is a block diagram of an example of an estimating model generating system 20 used to generate the estimating model used by the image forming apparatus 10.

As illustrated in FIG. 3, the estimating model generating system 20 includes an image forming apparatus 30 of which an apparatus model is the same as an apparatus model of the image forming apparatus 10 (refer to FIG. 1), a wattmeter 40 that measures power consumption of the image forming apparatus 30, and an electronic apparatus 50, such as a smartphone or a tablet, that stores therein the power consumption measured by the wattmeter 40.

Next, a method for generating the estimating model is described.

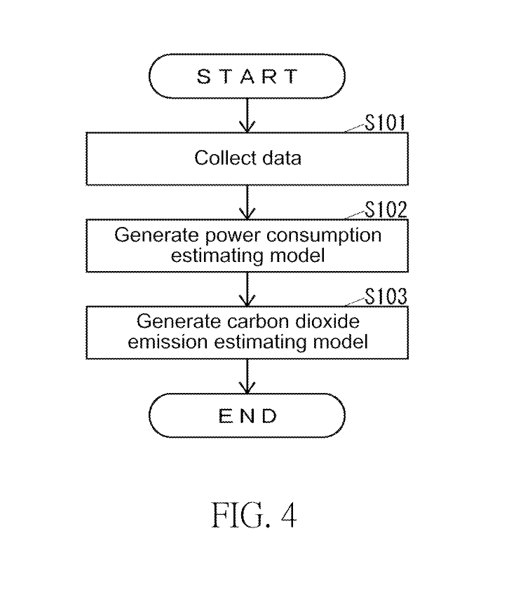

FIG. 4 is a flowchart of the method for generating the estimating model used by the image forming apparatus 10.

As illustrated in FIG. 4, an operator collects (S101) a large number of pieces of data used to generate the power consumption estimating model. Specifically, the operator accumulates data in the electronic apparatus 50 for each setting for a job, where power consumption measured by the wattmeter 40 when the image forming apparatus 30 executes a job, and a setting for the job executed by the image forming apparatus 30 are included in the data in association with each other.

When the process of S101 is terminated, the operator generates (S102) a power consumption estimating model by a decision tree algorithm using the data collected in S101. Specifically, the operator gives the electronic apparatus 50 an instruction to generate the power consumption estimating model corresponding to a regression model by a decision tree algorithm using the data collected in S101. Thus, the electronic apparatus 50 generates the power consumption estimating model corresponding to a regression model by a decision tree algorithm using the data collected in S101. The generation of the power consumption estimating model in S102 may be performed by machine learning.

When the process of S102 is terminated, the operator generates (S103) a carbon dioxide emission estimating model using the power consumption estimating model generated in S102. Specifically, the operator gives the electronic apparatus 50 an instruction to generate the carbon dioxide emission estimating model using the power consumption estimating model generated in S102. Thus, the electronic apparatus 50 generates the carbon dioxide emission estimating model by multiplying, by a coefficient of carbon dioxide emissions, the power consumption estimating model generated in S102.

In the estimating model generating system 20 illustrated in FIG. 3, only an estimating model for an image forming apparatus of which an apparatus model is the same as the apparatus model of the image forming apparatus 30 can be generated. Thus, a change in the apparatus model of an image forming apparatus in the estimating model generating system 20 makes it possible to generate estimating models for various apparatus models.

The estimating model generated by the method illustrated in FIG. 4 may be installed on an image forming apparatus of which an apparatus model is the same as the apparatus model of the image forming apparatus 30 such as the image forming apparatus 10.

Next, an operation performed by the image forming apparatus 10 upon executing a job is described.

A copying job is described below as an example of the type of job. However, the same applies to a job other than the copying job.

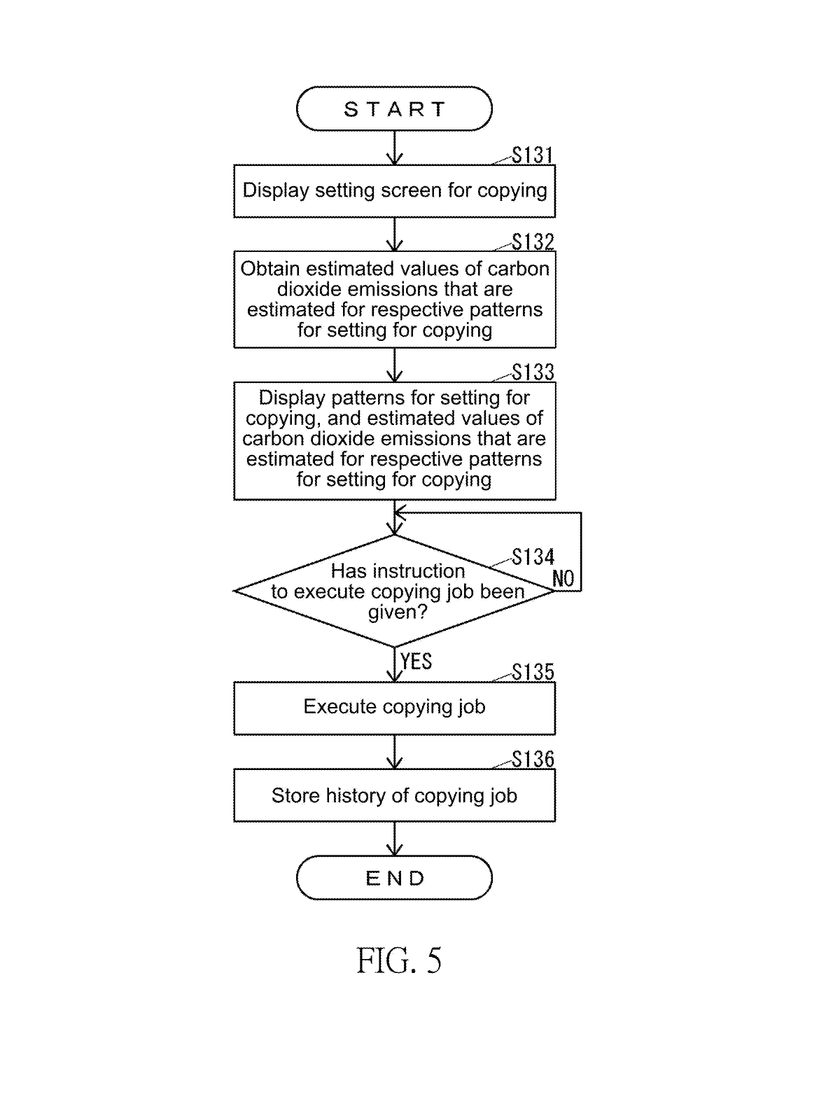

FIG. 5 is a flowchart of an operation performed by the image forming apparatus 10 upon executing a copying job.

When an instruction to display a setting screen for a copying job (hereinafter referred to as a "setting screen for copying") is given through the operation section 11, the controller 18 of the image forming apparatus 10 displays (S131) the setting screen for copying on the display section 12, as illustrated in FIG. 5.

When the process of S131 is terminated, the estimator 18a of the image forming apparatus 10 obtains (S132) estimated values of carbon dioxide emissions of the image forming apparatus 10 that are estimated for respective patterns of a plurality of patterns for a setting for the copying job (hereinafter referred to as a "setting for copying"), the estimated values being obtained using an estimating model for the copying job and the patterns for the setting for copying.

When the process of S132 is terminated, the estimator 18a displays (S133), on the setting screen for copying displayed in S131, the plurality of patterns for the setting for copying and the estimated values of carbon dioxide emissions of the image forming apparatus 10 that are estimated for the respective patterns of the plurality of patterns for the setting for copying and obtained in S132. Thus, when, for example, a user of the image forming apparatus 10 specifies the setting for copying by selecting one of the plurality of patterns for the setting for copying, the estimated values of carbon dioxide emissions of the image forming apparatus 10 are taken into consideration.

When the process of S133 is terminated, the controller 18 of the image forming apparatus 10 determines (S134) whether an instruction to execute the copying job has been given through the operation section 11, until the instruction to execute the copying job has been determined to be given through the operation section 11.

When the controller 18 determines, in S134, that the instruction to execute the copying job has been given through the operation section 11, the controller 18 executes (S135) the copying job using a setting for copying that is specified on the setting screen for copying.

When the process of S135 is terminated, the controller 18 stores (S136), in the job history information 17b, a history of the copying job executed in S135, and terminates the operation illustrated in FIG. 5.

In the operation illustrated in FIG. 5, the estimator 18a displays estimated values of carbon dioxide emissions of the image forming apparatus 10 that are estimated for respective patterns of a plurality of patterns for a setting for copying. However, when a setting for copying is specified on a setting screen for copying, the estimator 18a may obtain an estimated value of carbon dioxide emissions of the image forming apparatus 10, using the setting for copying specified on the setting screen for copying, and an estimating model for a copying job, and may display the obtained estimated value on the setting screen for copying.

Next, an operation performed by the image forming apparatus 10 upon displaying a total of carbon dioxide emissions is described.

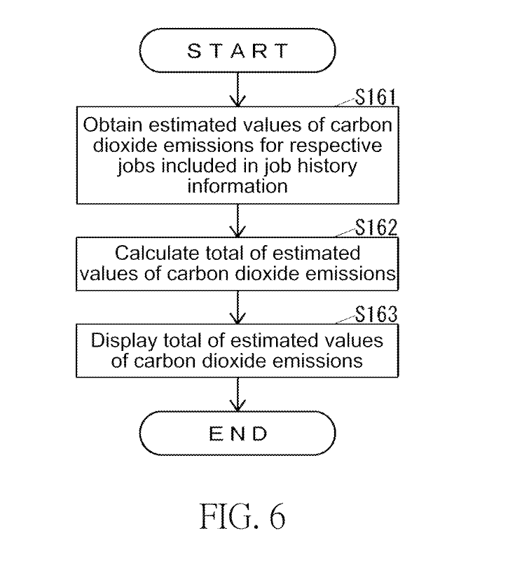

FIG. 6 is a flowchart of an operation performed by the image forming apparatus upon displaying a total of carbon dioxide emissions.

A user of the image forming apparatus 10 can give the image forming apparatus 10 an instruction to display, through the operation section 11, a total of carbon dioxide emissions of the image forming apparatus 10. When the instruction to display the total of the carbon dioxide emissions of the image forming apparatus 10 is given, the estimator 18a of the image forming apparatus 10 obtains (S161), for each job included in the job history information 17b, an estimated value of carbon dioxide emissions of the image forming apparatus 10, using a setting for the job that is included in the job history information 17b, and an estimating model corresponding to the type of the job that is included in the job history information 17b, as illustrated in FIG. 6.

When the process of S161 is terminated, the estimator 18a adds all of the estimated values obtained in S161 to calculate (S162) the total of the estimated values of carbon dioxide emissions of the image forming apparatus 10.

When the process of S162 is terminated, the estimator 18a displays (S163), on the display section 12, the total of the estimated values of carbon dioxide emissions of the image forming apparatus 10 that is calculated in S162. This enables the user of the image forming apparatus 10 to recognize the total of the estimated values of carbon dioxide emissions of the image forming apparatus 10.

In the operation illustrated in FIG. 6, the estimator 18a displays totals of estimated values of carbon dioxide emissions of the image forming apparatus 10 that are obtained for all of periods of time in times past. However, the estimator 18a may display a total of estimated values of carbon dioxide emissions of the image forming apparatus 10 that is obtained for a specific period of time, such as a period of time that is specified by the user of the image forming apparatus 10 through the operation section 11.

Without power consumption of the image forming apparatus 10 being measured by a wattmeter, the image forming apparatus 10 can obtain an estimated value of carbon dioxide emissions of the image forming apparatus 10, using an estimating model.

A recording medium on which an image is printed by the image forming apparatus 10 is shipped in a state in which carbon dioxide emissions related to the recording medium are already calculated upon production of the recording medium. Likewise, toner used by the image forming apparatus 10 to perform printing on the recording medium is shipped in a state in which carbon dioxide emissions related to the toner are already calculated upon production of the toner. Thus, estimated values of carbon dioxide emissions for an amount of use of the recording medium and for an amount of use of the toner are not to be included in the estimated value of carbon dioxide emissions caused when the image forming apparatus 10 executes a job. Since the estimator 18a does not include estimated values of carbon dioxide emissions for an amount of use of the recording medium and for an amount of use of the toner in an estimated value of carbon dioxide emissions caused when the image forming apparatus 10 executes a job, the accuracy of the estimated value of carbon dioxide emissions caused when the electronic apparatus 10 executes a job can be improved.

In the present embodiment, the estimator 18a performs display to notify an estimated value of carbon dioxide emissions of the image forming apparatus 10. However, the estimator 18a may notify the estimated value of carbon dioxide emissions of the image forming apparatus 10, using a method other than performing display. For example, the estimator 18a may notify, using sound, the estimated value of carbon dioxide emissions of the image forming apparatus 10.

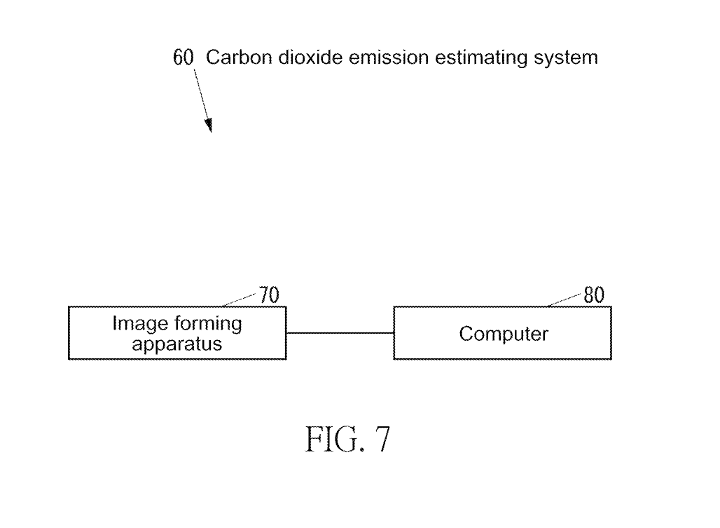

In the configuration described above, the estimating system only includes the image forming apparatus. However, the estimating system according to the present embodiment may include the image forming apparatus and at least one computer other than the image forming apparatus. For example, the estimating system according to the present embodiment may have a configuration illustrated in FIG. 7.

FIG. 7 is a block diagram of an example of an estimating system according to the present embodiment that is different from the example illustrated in FIG. 1.

An estimating system 60 illustrated in FIG. 7 includes an image forming apparatus 70 and a computer 80. The image forming apparatus 70 and the computer 80 are communicably connected to each other. The computer 80 receives, from the image forming apparatus 70, the type of a job that is to be executed or has been executed by the image forming apparatus 70, and a setting for the job. As in the process of S132 or S161, the computer 80 obtains an estimated value of carbon dioxide emissions of the image forming apparatus 70 on the basis of the received type of job and the received setting for the job. The estimated value of carbon dioxide emissions of the image forming apparatus 70 that is obtained by the computer 80 may be notified by the image forming apparatus 70 or the computer 80.

In related art, carbon dioxide emissions for the type of paper and an amount of use of the paper, and carbon dioxide emissions for an amount of use of toner are calculated to be added in addition to carbon dioxide emissions caused by electric power being used. Each of the paper and the toner is shipped in a state in which the carbon dioxide emissions related to a corresponding one of the paper and the toner are already calculated upon its production. Thus, if carbon dioxide emissions related to paper and carbon dioxide emissions related to toner are included in carbon dioxide emissions caused by the image forming apparatus being used, the carbon dioxide emissions caused by the image forming apparatus being used will not be calculated accurately. When carbon dioxide emissions caused by electric power being used are calculated, power consumption caused by performing monochrome printing on a single A4-sized page and measured in advance using an internal module, or what is calculated from power consumption measured using a built-in wattmeter is held as reference electric power, and the reference power quantity is multiplied by a coefficient of print mode (color) and a layout coefficient to calculate power consumption. The calculated power consumption is multiplied by carbon dioxide emissions per unit power consumption to obtain carbon dioxide emissions. Actual measurement is necessary to determine reference electric power, and there is a need for an apparatus used to measure electric power. Further, it is difficult to measure power consumption accurately only using two kinds of coefficients that are the color coefficient and the layout coefficient.

In related art, carbon dioxide emissions for the type of paper and an amount of use of the paper, and carbon dioxide emissions for an amount of use of toner are calculated to be added in addition to carbon dioxide emissions caused by electric power being used. Each of the paper and the toner is shipped in a state in which the carbon dioxide emissions related to a corresponding one of the paper and the toner are already calculated upon its production. Thus, if carbon dioxide emissions related to paper and carbon dioxide emissions related to toner are included in carbon dioxide emissions caused by the image forming apparatus being used, the carbon dioxide emissions caused by the image forming apparatus being used will not be calculated accurately. When carbon dioxide emissions caused by electric power being used are calculated, power consumption of a mechanism section that operates depending on a setting for printing is calculated, and the number of times of operation performed by the operating mechanism section is determined by the number of sheets of paper printed and the number of sides on which printing is performed. Power consumption determined for each mechanism section is multiplied by a corresponding number of times of operation, and values obtained by the multiplication are added to calculate power consumption caused on a job. The calculated power consumption is multiplied by carbon dioxide emissions per unit power consumption to obtain carbon dioxide emissions caused by power consumption. There is a need to determine electric power for each operation portion, and to perform measurement in advance. Further, it is difficult to reflect factors that are not measured only using the number of times of operation. For example, if a printing speed is changed due to the paper size or the type of paper, electric power necessary to maintain a fixing temperature will be changed due to a change in printing time. Thus, it is difficult to perform prediction only using the number of times of operation.

According to the present embodiment, a set value of the image forming apparatus, a counter value, execution information regarding execution of a job, and a log of the image forming apparatus are acquired. A decision tree model is generated on the basis of the acquired information, and consumption of power used by the image forming apparatus per day can be estimated using the model.

Carbon dioxide emissions can be calculated by multiplying power consumption by the coefficient of carbon dioxide emissions that is defined by the Ministry of the Environment. Thus, carbon dioxide emissions can be derived by power consumption of the image forming apparatus being estimated.

The intended use of the image forming apparatus is execution of jobs such as copying and printing, and most power consumption is considered to be caused due to the execution of jobs. Actually, power consumption can be estimated with a higher degree of accuracy using a sleep condition and a heater-related potion of set values, in addition to the execution of jobs.

It is conceivable that, without a power meter, power consumption of the image forming apparatus per day could be estimated from a set value of the image forming apparatus and job execution information regarding the image forming apparatus using a regression model formula to estimate carbon dioxide emissions. However, if a regression model formula is created, it will be difficult to perform achievement without there being linearity between pieces of data used to form the regression model formula, and there will be a need for unique feature amount engineering in order to secure linearity.

On the other hand, a decision tree algorithm is adopted in the present embodiment. The decision tree model has characteristics in that a categorical variable can be used with no change, non-linear relationships can be automatically captured, and the model is not dependent on the scale of a feature amount. The adoption of a decision tree algorithm makes it possible to reduce loads due to feature amount engineering. Further, this results in obtaining a model that enables an improvement of the accuracy.

Although each embodiment and each modified example of the present technology have been described above, the present technology is not limited to the above-mentioned embodiments, and various modifications can be made without departing from the gist of the present technology as a matter of course.

What is claimed is:

1. An estimating system, comprising
an estimator that obtains an estimated value of power consumption caused when an electronic apparatus executes a job, using a power consumption estimating model that is a regression model used to estimate the power consumption, wherein
the regression model is created by a decision tree algorithm,
a target variable of the regression model represents the power consumption,
an explanatory variable of the regression model represents execution information regarding execution of a job, set-value information regarding a set value for a state of the electronic apparatus, and time information regarding a time taken for the job or duration of the state, and
there exists a plurality of the explanatory variables of the regression model depending on a type of a setting for the job or the state of the electronic apparatus.

2. The estimating system according to claim 1, wherein
the estimator calculates the estimated value of power consumption by ensemble learning in which results obtained using the power consumption estimating model including a plurality of the regression models are averaged or some of the results are combined on a basis of a majority decision.

3. The estimating system according to claim 1, wherein
the estimator obtains an estimated value of carbon dioxide emissions by multiplying the estimated value of power consumption by a coefficient of carbon dioxide emissions.

4. An electronic apparatus, comprising
an estimator that obtains an estimated value of power consumption caused when the electronic apparatus executes a job, using a power consumption estimating model that is a regression model used to estimate the power consumption, wherein
the regression model is created by a decision tree algorithm,
a target variable of the regression model represents the power consumption,
an explanatory variable of the regression model represents execution information regarding execution of a job, set-value information regarding a set value for a state of the electronic apparatus, and time information regarding a time taken for the job or duration of the state, and
there exists a plurality of the explanatory variables of the regression model depending on a type of a setting for the job or the state of the electronic apparatus.

5. An estimating method that is performed by an estimating program being executed by a control circuit of an electronic apparatus, the estimating method comprising
obtaining an estimated value of power consumption caused when the electronic apparatus executes a job, using a power consumption estimating model that is a regression model used to estimate the power consumption, wherein
the regression model is created by a decision tree algorithm,
a target variable of the regression model represents the power consumption,
an explanatory variable of the regression model represents execution information regarding execution of a job, set-value information regarding a set value for a state of the electronic apparatus, and time information regarding a time taken for the job or duration of the state, and
there exists a plurality of the explanatory variables of the regression model depending on a type of a setting for the job or the state of the electronic apparatus.
